(19) United States
(12) Patent Application Publication
(10) Pub. No.: US 2022/0295708 A1
(43) Pub. Date: Sep. 22, 2022

(54) GOLF COURSE IMPLEMENT LIFT SYSTEM

(71) Applicant: Deere & Company, Moline, IL (US)

(72) Inventors: Harry K. Voelp, IV, Evans, GA (US); Zachary A. Ritchie, West Des Moines, IA (US); Jason D. Wood, Des Moines, IA (US)

(21) Appl. No.: 17/249,911

(22) Filed: Mar. 18, 2021

(51) Int. Cl. A01D 75/18; A01B 61/02

(52) U.S. Cl. CPC A01D 75/185; A01B 61/02

(57) ABSTRACT

A golf course implement lift system includes a global positioning system for mapping a plurality of obstacles on a golf course, and an electro-hydraulic three point hitch with a towed implement attached thereto. The electro-hydraulic three point hitch is raised when the global positioning system detects the towed implement is approaching one of the plurality of obstacles.

### FIELD OF THE INVENTION

This invention relates generally to towed implements such as aerators used to maintain turf on golf courses or parks where objects or obstacles such as sprinkler heads are located.

### BACKGROUND OF THE INVENTION

Towed implements including aerators, de-thatchers and verticutters may be used for turf maintenance on golf courses or parks where sprinkler heads or other objects such as valve boxes, yardage markers, and drainage inlets may be located. Towed implements may have multiple ground penetrating tines or blades, and may be attached to a three point hitch behind a tractor. The sprinkler heads or other objects may be difficult for the operator to see especially if hidden by grass, located in the ground, or during early morning or evening maintenance. For those reasons, objects may need to be marked before using the implements, or the operator may slow down and maneuver around each object and/or raise and then lower the three point hitch to prevent the implements from hitting the sprinkler heads or other objects.

A golf course implement lift system is needed that reduces the risk of damage to towed implements, sprinkler heads or other objects. A golf course implement lift system is needed that does not require the operator to see each obstacle and maneuver around or raise and lower towed implements attached to a three point hitch behind the tractor.

### SUMMARY OF THE INVENTION

A golf course implement lift system for a turf maintenance implement attached to a three point hitch behind a tractor, including a global positioning system on the tractor that signals a hitch controller to raise the implement when it detects the tractor is located where a working point of the three point hitch is approaching an object, and to lower the three point hitch when the global positioning system detects the tractor is located where the working point of the three point hitch is past the object.

### BRIEF DESCRIPTION OF THE DRAWINGS

FIG. 1 is a rear perspective view of a golf course implement lift system used with a towed implement attached to a three point hitch behind a tractor before reaching an obstacle in the ground according to a first embodiment of the invention.

FIG. 2 is a rear perspective view of a golf course implement lift system used with a towed implement attached to a three point hitch behind a tractor after reaching an obstacle in the ground according to a first embodiment of the invention.

FIG. 3 is a top view of a golf course implement lift system used with a towed implement attached to a three point hitch of a tractor according to a first embodiment of the invention.

### DESCRIPTION OF THE PREFERRED EMBODIMENT

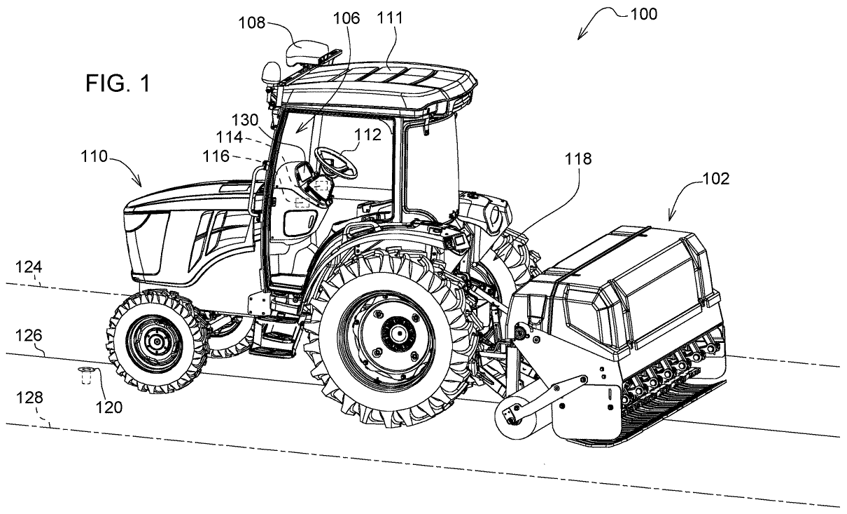

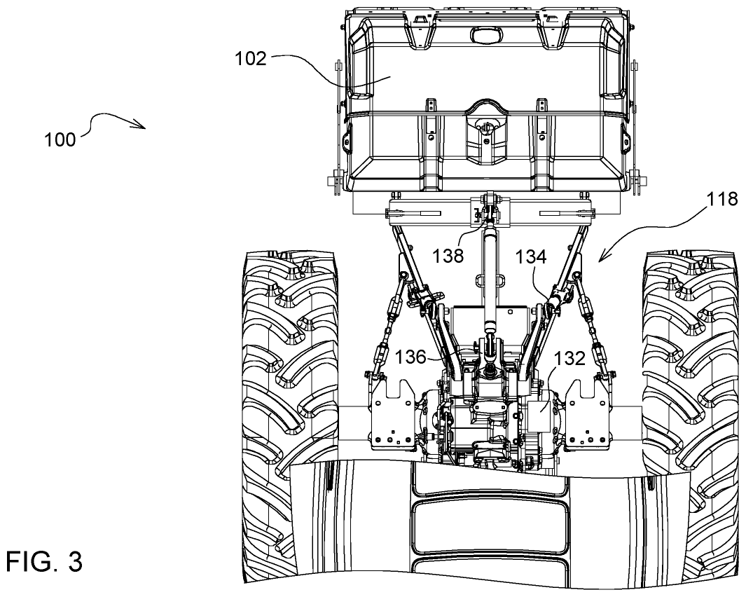

In one embodiment shown in FIGS. 1-3, golf course implement lift system 100 may be used with a towed implement 102 for turf maintenance such as an aerator, de-thatcher or verticutter. The towed implement may have multiple ground penetrating tines or blades. For example, the aerator may have multiple tines that enter and exit the turf using a reciprocating mechanism. The towed implement may be attached to a three point hitch 118 behind tractor 110.

In one embodiment, golf course implement lift system 100 may include Global Positioning System (GPS) receiver 108. The GPS receiver may receive signals to identify and measure the position of the tractor that are accurate to several inches, using correction satellites for improved signal and accuracy. Optionally, Real Time Kinematic (RTK) corrections also may be used along with the GPS receiver to improve accuracy. The GPS receiver may be mounted on tractor 110. For example, the GPS receiver may be mounted to the cab roof 111 of the tractor.

In one embodiment, golf course implement lift system 100 may include automated guidance system 106 which may be used to steer the tractor instead of steering wheel 112. For example, the automated guidance system may be an AutoTrac™ system offered by Deere & Company. The automated guidance system may receive information from GPS receiver 108 and provide signals to steering controller 116 which controls electrohydraulic steering control valve 114. The steering control valve may provide hydraulic fluid to steering cylinders to steer the tractor and maintain the desired travel direction. For each hole, the automated guidance system may provide a series of guidance lines 124, 126, 128 for the tractor and towed implement to follow. The golf course implement system also may include operator display/interface 130 in the cab.

In one embodiment, golf course implement lift system 100 may include generating a map of each golf course or golf course hole, including the edge of the fairway or property which may be traced as the external or field boundary. The GPS system or a hand held device also may be used to mark the location of each object or obstacle. For example, the objects or obstacles may be in ground such as sprinkler head 120, valve box, yardage marker or drainage inlet. The system may include a flags application to identify the GPS location of the tractor for each obstacle 120. The GPS location of the tractor may be selected where the working point of the implement is located over the in-ground obstacle 120. For example, the working point may be the center link of the three point hitch. The automated guidance system also may be used to generate a boundary around each obstacle, such as a circle with a specified radius from the obstacle.

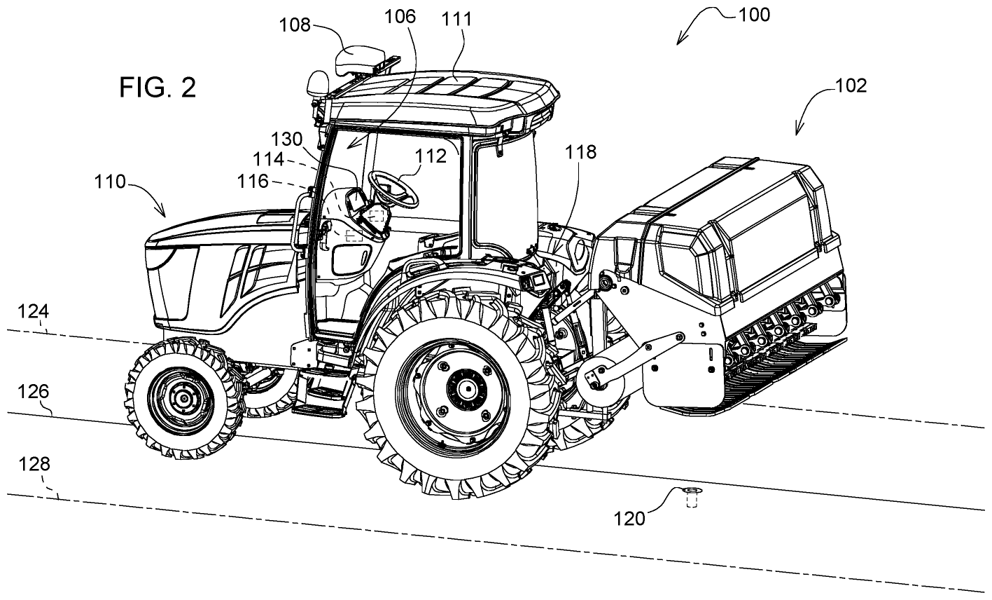

In one embodiment, golf course implement lift system 100 may include electro-hydraulic three point hitch 118 that automatically raises the towed implement 102 when approaching each marked object or obstacle. The electro-hydraulic three point hitch may have a controller driven rear hitch valve 136 that may be used to automatically raise the towed implement before the implement contacts the obstacle. When the GPS receiver detects the tractor has moved to a location where working point 138 is approaching or within the boundary area of an obstacle, hitch controller 132 may command the hitch to raise the towed implement to the position shown in FIG. 2. When the GPS receiver detects the tractor has moved the towed implement to a location past the boundary area of the obstacle, the hitch controller 132 may command the hitch to lower the towed implement back to the working position. Hitch position sensor 134 may be used to provide information for the position of the hitch.

In one embodiment, the GPS receiver on the tractor may send a raise signal to the hitch when approaching an obstacle. The distance from the obstacle may be a set distance, or may be based on the boundary around the obstacle and/or tractor speed. For example, the GPS receiver may detect the tractor speed, as well as the obstacle boundary that was flagged. Thus, the tractor speed and obstacle boundary may be variable inputs that the hitch controller may use for determining when to raise the hitch as the towed implement is approaching an obstacle.

In one embodiment, when starting each pass, the hitch may be in the working position shown in FIG. 1, and the tractor may use an automated guidance system to steer the tractor. The tractor may follow guidance line 126 which may be parallel to one or more adjacent guidance lines 124, 128 along the fairway or property. When the tractor reaches the external or field boundary at the edge of the fairway or property, the operator may raise the hitch and steer the tractor manually to the adjacent guidance line, or use the automated guidance system to raise the hitch and turn the tractor around to follow the adjacent guidance line.

Having described the preferred embodiments, it will become apparent that various modifications can be made without departing from the scope of the invention as defined in the accompanying claims.

1. A golf course implement lift system, comprising:
a global positioning system for mapping a plurality of obstacles on a golf course;
an electro-hydraulic three point hitch with a towed implement attached thereto; the electro-hydraulic three point hitch is raised when the global positioning system detects the towed implement is approaching one of the plurality of obstacles.

2. The golf course implement lift system of claim 1 further comprising an automated guidance system that steers the tractor on a series of guidance lines on the golf course.

3. The golf course implement lift system of claim 1 wherein the towed implement is an aerator.

4. The golf course implement lift system of claim 1 wherein the electro-hydraulic three point hitch is raised when a working point on the hitch is approaching one of the plurality of obstacles.

5. A golf course implement lift system, comprising:
an aerator attached to a three point hitch behind a tractor;
a global positioning system on the tractor; and
a hitch controller that raises the three point hitch when the global positioning system detects the tractor is located where a working point of the three point hitch is approaching an in-ground obstacle, and lowers the three point hitch when the global positioning system detects the tractor is located where the working point of the three point hitch is past the in-ground obstacle.

6. The golf course implement lift system of claim 5 wherein the global positioning system stores a location for each in-ground obstacle.

7. The golf course implement lift system of claim 5 wherein the automated guidance system steers the tractor on a series of guidance lines on a golf course.

8. A golf course implement lift system, comprising:
a tractor with an electro-hydraulic three point hitch towing an implement for turf maintenance;
a global positioning system receiver detecting the location of the tractor relative to a plurality of in-ground obstacles, and signaling the electro-hydraulic three point hitch to raise the implement when approaching any of the plurality of in-ground obstacles.

9. The golf course implement lift system of claim 8 wherein the implement is an aerator.

10. The golf course implement lift system of claim 8 wherein the electro-hydraulic three point hitch is raised based on a tractor speed and a boundary area around each of the in-ground obstacles.
